(19) United States
(12) Patent Application Publication
(10) Pub. No.: US 2026/0071656 A1
(43) Pub. Date: Mar. 12, 2026

(54) ROLLER AND CAM CLUTCH UNIT

(71) Applicant: TSUBAKIMOTO CHAIN CO., Osaka (JP)

(72) Inventors: Yuto Hanawa, Osaka (JP); Yuji Kurematsu, Osaka (JP)

(73) Assignee: TSUBAKIMOTO CHAIN CO., Osaka (JP)

(21) Appl. No.: 19/314,759

(22) Filed: Aug. 29, 2025

(30) Foreign Application Priority Data
Sep. 12, 2024 (JP) 2024-158445

(51) Int. Cl. F16D 41/07; F16C 13/00

(52) U.S. Cl. CPC F16D 41/07; F16C 13/00

(57) ABSTRACT

An object of the present invention is to provide a roller for use in a cam clutch unit, capable of reducing contact with a spring, and a cam clutch unit that uses the roller.

Rollers 20, 30, 40 are used in a cam clutch unit 10 including at least a plurality of cams 11 arranged between an inner ring and an outer ring provided coaxially and relatively rotatably, and an annular spring 12 for biasing the cams 11, the rollers 20, 30, 40 being arranged between the inner ring and the outer ring together with the cams 11, and comprising a pair of roller portions 21, 31, 41, and pin portions 22, 32, 42 provided between the roller portions 21, 31, 41, wherein at least one of the roller portions 21, 31, 41 and the pin portions 22, 32, 42 are separate entities.

### BACKGROUND OF THE INVENTION

1. Field of the Invention

The present invention relates to a roller and a cam clutch unit.

### 2. Description of the Related Art

As a cam clutch unit for transmitting and disconnecting torque between an input shaft and an output shaft, there exists a cam clutch unit that includes a plurality of cams and a plurality of rollers arranged in a circumferential direction between an inner ring and an outer ring provided coaxially and relatively rotatably, and an annular spring for biasing the cams. There also exists a cam clutch unit that is provided with a cage ring having a plurality of pocket portions for restricting relative circumferential movement of the cams and the rollers.

For example, in the case of a cam clutch unit provided with a cage ring described in Japanese Patent Application Publication No. 2023-161566, a plurality of cams and a plurality of rollers are housed in pocket portions of the cage ring, and relative movement of the cams and the rollers in the circumferential direction is restricted.

In this case, as shown in FIG. 8, a roller has a groove portion 102 formed in the circumferential direction between a pair of roller portions 101 functioning as a roller 100, and a spring 103 is housed in the groove portion 102 to bias the roller 100 toward an inner ring.

### SUMMARY OF THE INVENTION

In the cam clutch unit using such a roller 100, since the groove portion 102 of the roller 100 is not sufficiently deep with respect to the roller surface of the roller portions 101, there is a risk that the groove portion 102 comes into contact with the spring 103, causing drag torque (frictional sliding) between the spring 103 and the roller 100. Further, the spring 103 may be deteriorated by wear with the roller 100, and may affect the life of the cam clutch unit itself. Further, since the groove portion 102 is located at a position higher than the spring contact point of the cam, there is a possibility that the cam adjacent to the roller 100 cannot be effectively pressurized by the spring 103.

On the other hand, since the groove portion 102 of the roller 100 is formed by cutting or rolling, the depth of the groove that can be formed is limited, and the groove depth cannot be set to such a depth that can reduce contact with the spring 103.

Accordingly, the present invention has been achieved in view of the above-described problems, and an object of the present invention is to provide a roller for use in a cam clutch unit capable of reducing contact with a spring, and a cam clutch unit that uses the roller and can suppress generation of drag torque.

A roller of the present invention is used in a cam clutch unit that includes at least a plurality of cams arranged between an inner ring and an outer ring provided coaxially and relatively rotatably, and an annular spring that biases the cams, the roller being arranged between the inner ring and the outer ring together with the cams, and comprising a pair of roller portions and a pin portion provided between the roller portions, wherein at least one of the roller portions and the pin portion are separate entities.

The roller of the present invention comprises a pair of roller portions and a pin portion provided between the roller portions, and at least one of the roller portions and the pin portion are separate entities, allowing for the diameter of the pin portion to be set arbitrarily. Thus, the depth from a roller surface of a groove portion composed of end surfaces of the roller portions facing each other and a surface of the pin portion can be set to a desired depth, and contact with the spring can be reduced.

It is preferred that the roller portion separate from the pin portion be provided with a through hole penetrating the end surface thereof, and that the pin portion be inserted into the through hole. Since the pin portion is inserted into the through hole, the roller can be configured by simple assembly of parts.

It is preferred that the roller portion separate from the pin portion have a recess portion formed on the end surface thereof, and that the pin portion be inserted into the recess portion. Since the pin portion is inserted into the recess portion, the roller can be configured by simple assembly of components.

It is preferred that the pin portion be inserted in such a manner as to penetrate the through hole and project to the outside of the end surface on the outside of the roller. With this configuration, contact with the cage ring or the like is not an end surface of the roller but an end protruding to the outside of the pin portion, resulting in a reduction in contact area and reduction in frictional sliding between the roller and a housing.

It is preferred that the pin portion be provided in a clearance-fitting manner with respect to the roller portion. When the roller is constructed by clearance-fitting, the pin portion preferably functions as a retaining pin in the outer diameter direction of the roller.

It is preferred that the roller portions and the pin portion are all separate from each other. Since these portions are separate entities, there is an advantage that the cutting work is reduce, allowing for easy construction of the roller.

The cam clutch unit of the present invention is characterized by comprising a plurality of cams arranged between an inner ring and an outer ring provided coaxially and relatively rotatably, a roller described in any of the foregoing, and an annular spring biasing the cams. Since the roller described in any of the foregoing can reduce contact with the spring, generation of drag torque between the roller and the spring can be suppressed.

According to the present invention, a roller for a cam clutch unit that can set a desired groove depth, and a cam clutch unit using this roller can be provided.

### BRIEF DESCRIPTION OF THE DRAWINGS

FIG. 1 is a perspective view showing a cam clutch unit according to Embodiment 1 of the present invention;

FIG. 2 is a perspective view showing a roller according to Embodiment 1 of the present invention;

FIG. 3 is a front view showing the roller according to Embodiment 1 of the present invention;

FIG. 4 is an exploded perspective view showing the roller according to Embodiment 1 of the present invention;

FIG. 5 is a perspective view showing a roller according to Embodiment 2 of the present invention;

FIG. 6 is a cross-sectional view showing the roller according to Embodiment 2 of the present invention;

FIG. 7 is a schematic front view showing a roller according to Embodiment 3 of the present invention; and

FIG. 8 is a front view showing a conventional roller.

### DESCRIPTION OF THE PREFERRED EMBODIMENTS

### Embodiment 1

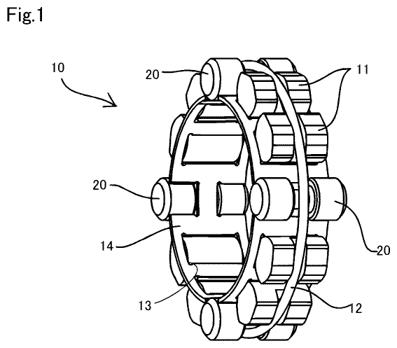

FIG. 1 shows a cam clutch unit 10 according to the present invention. The cam clutch unit 10 includes a plurality of cams 11 and a plurality of rollers 20 arranged between an inner ring and an outer ring (not shown) arranged coaxially in a circumferential direction, an annular spring 12 for biasing the cams 11, and a cage ring 14 that has pocket portions 13 for housing the cams 11 and the rollers 20, respectively. The plurality of cams 11 and the plurality of rollers 20 are housed in the pocket portions 13 of the cage ring 14, thereby restricting relative movement thereof in the circumferential direction.

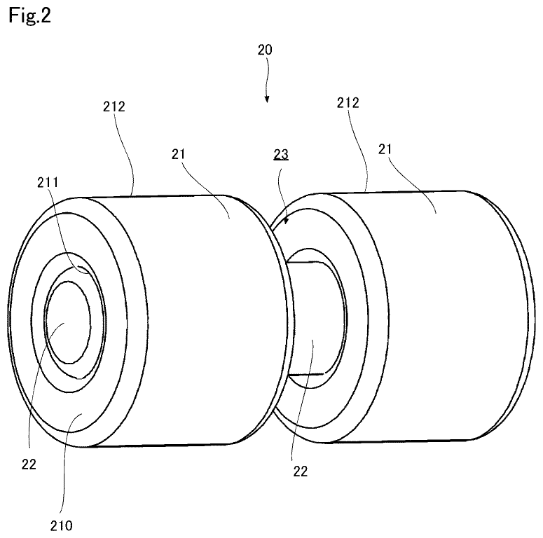

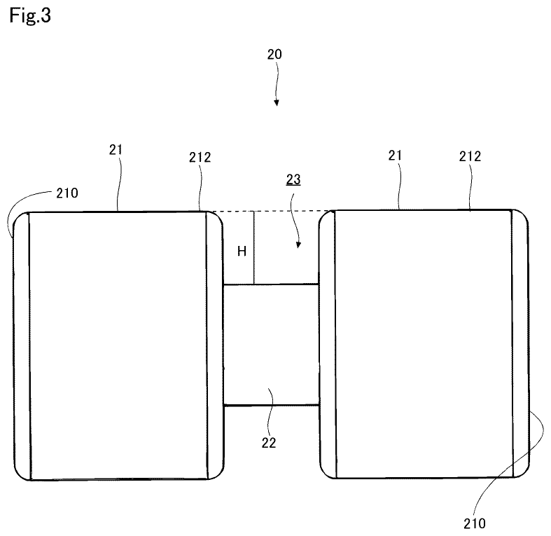

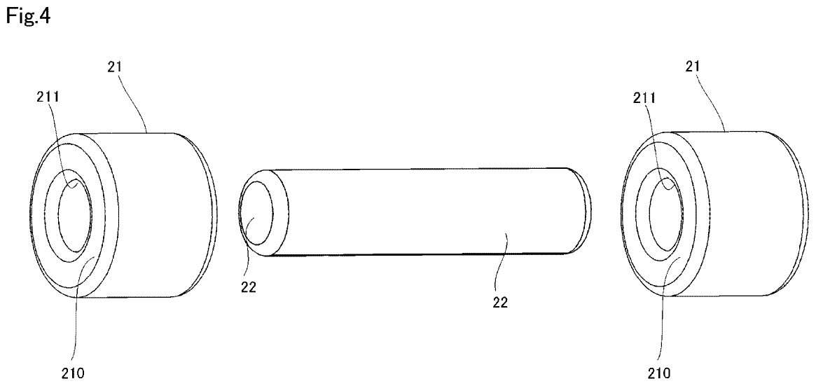

The rollers 20 will be described with reference to FIGS. 2 to 4. The roller 20 of the present embodiment comprises a pair of roller portions 21 functioning as rollers and a pin portion 22 provided between the roller portions 21. The roller portion 21 is cylindrical and includes two end surfaces 210 and a roller surface 212. The roller portions 21 are each provided with a through hole 211 penetrating the centers of the end surfaces 210 on both sides. An opening shape of the through hole 211 is circular, and a pin portion 22 having a solid cylindrical shape is inserted into the through hole 211. In the present embodiment, both ends of the pin portion 22 are inserted and fixed into the through hole 211 by press-fitting, and the ends 221 of the pin portion 22 are exposed from the opening of the through hole 211. In the present embodiment, the ends 221 of the pin portions 22 are configured to be flush with the end surfaces 210 of the roller portions 21 in the inserted and fixed state.

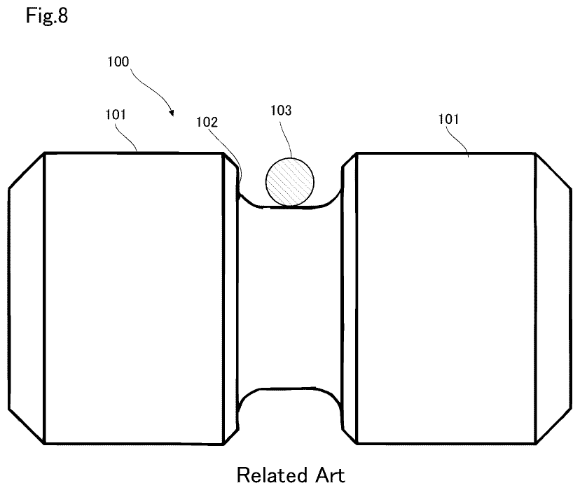

In the present embodiment, since the roller portion 21 and the pin portion 22 are provided separately and are assembled by press-fitting, the pin portion 22 does not need to be formed by cutting or the like, and the diameter of the pin portion 22 can be arbitrarily determined. Accordingly, the depth H of a groove portion 23, which is formed by the opposing end surfaces 210 of the roller portions 21 and surfaces of the pin portions 22, relative to the roller surface 212, can be determined arbitrarily, and as a result, the depth H of the groove portion 23 can be made deeper than in the conventional one. For example, in the conventional roller formed by cutting as shown in FIG. 8, the ratio of the diameter of the pin portion to the diameter of the end surface of the roller portion is greater than 40%, but in the present embodiment, for example, the ratio of the diameter of the pin portion 22 to the diameter of the end surface 210 of the roller portion 21 can be 40% or less.

Thus, contact between the roller portion 21 and the spring 12 can be suppressed, and frictional sliding between the roller portion 21 and the spring 12 can be reduced. Moreover, the manufacturing cost can also be reduced by the simple assembly between the rollers and pins. Further, since contact between the pin portion 22 and the spring 12 can be suppressed, the set load of the spring 12 can be reduced. Further, since the pressing force from the spring 12 to the roller 20 is reduced, the cam 11 can be effectively pressed, the spring 12 can be prevented from being deteriorated due to wear, and the life of the cam clutch unit 10 itself can be extended.

In the present embodiment, the pin portion 22 is inserted and fixed into the roller portion 21 by press-fitting, but the form of the insertion is not limited to this; the pin portion 22 may be clearance-fitted into the roller portion 21. In the case of clearance-fitting, the pin portion 22 can be utilized to prevent the roller portion 21 from coming off in the outer diameter direction, and even this case is preferable because contact with the spring 12 can be suppressed. Further, although the cam clutch unit 10 provided with the cage ring 14 has been illustrated in the present embodiment, the roller 20 of the present embodiment can be preferably applied to a cam clutch unit that does not have the cage ring 14.

### Embodiment 2

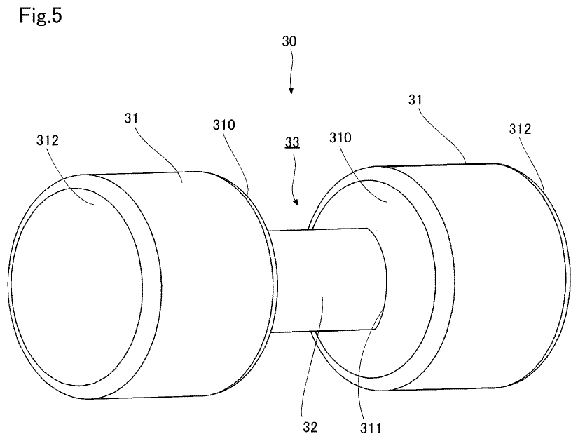

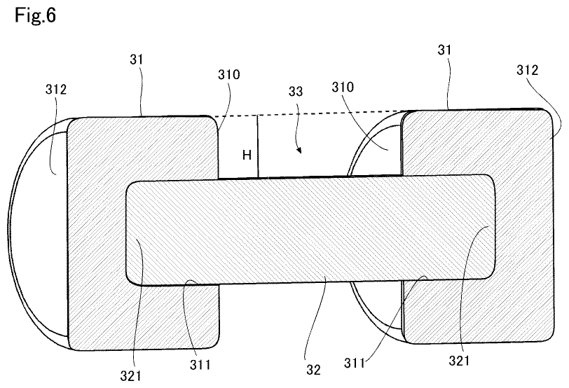

A roller 30 according to the present embodiment will be described with reference to FIGS. 5 and 6. Note that the descriptions of the same points as those in the other embodiment will be omitted, and the same components will be used as needed.

The roller 30 of the present embodiment includes a pair of roller portions 31 functioning as rollers and a pin portion 32 provided between the roller portions 31. The roller portions 31 are respectively provided with recess portion 311 at the centers of opposing end surfaces 310. An opening shape of the recess portion 311 is circular. The recess portion 311 is not formed on end surfaces 312 located on both end sides of the roller 30, that is, end surfaces 312 not facing each other. That is, in the present embodiment, the pin portion 32 is inserted and fixed into the recess portions 311 by press-fitting, and the ends 321 of the pin portion 32 are in close contact with bottom surfaces of the recess portions 311 of the roller portion 31 in the inserted and fixed state.

In the present embodiment as well, since the depth H of a groove portion 33 can be arbitrarily determined by the diameter of the pin portion 32, similar to Embodiment 1, the depth H of the groove portion 33 of the roller 30 is increased to suppress contact between the roller 30 and the spring 12, and frictional sliding between the roller 30 and the spring 12 can be reduced.

In the present embodiment as well, the pin portion 32 is inserted and fixed into the roller portion 31 by press-fitting, but the form of the insertion is not limited to this; the pin portion 32 may be clearance-fitted into the roller portion 31. In Embodiment 1, if the pin portion 22 is clearance-fitted to the roller portion 21, the roller portion 21 may come close to the center and come into contact with the spring 12, but if the pin portion 32 is fitted to the recess portion 311 as in the present embodiment, such contact can be suppressed even if they are clearance-fitted. Further, although the cam clutch unit 10 provided with the cage ring 14 has been illustrated in the present embodiment, the roller 30 of the present embodiment can be preferably applied to a cam clutch unit that does not have the cage ring 14.

### Embodiment 3

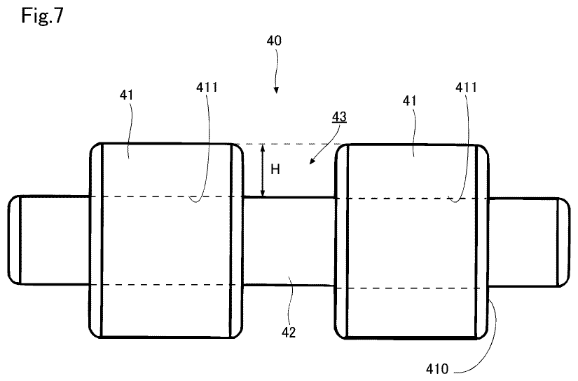

A roller 40 according to the present embodiment will be described with reference to FIG. 7. Note that the descriptions of the same points as those in the other embodiments will be omitted, and the same components will be used as needed.

The roller 40 of the present embodiment includes a pair of roller portions 41 functioning as rollers and a pin portion 42 provided between the roller portions 41. The roller portions 41 are each provided with a through hole 411 penetrating the centers of end surfaces 410 on both sides. An opening shape of the through hole 411 is circular, and each end of the pin portion 42, which is in a solid cylindrical shape, is inserted and fixed into the through hole 411 by press-fitting. In the present embodiment, the ends of the pin portion 42 are inserted and fixed so as to protrude outwardly from the end surfaces 410 of the roller portion 41.

In the present embodiment as well, since the diameter of the pin portion 42 can be set to a desired value in the same manner as in Embodiment 1, the depth H of the groove portion 43 of the roller 40 can be increased to suppress contact between the roller portion 41 and the spring 12, and frictional sliding between the roller portion 41 and the spring 12 can be reduced. Further, in Embodiment 1, the end surface 210 of the roller portion 21 comes into contact with the cage ring 14, but in the present embodiment, the pin portion 42 protruding outwardly from the roller portion 41 comes into contact with the cage ring 14, so that the contact area decreases, and frictional sliding between the roller 40 and the cage ring 14 can be further reduced. Note that, when the pin portion 42 is inserted and fixed into the roller portion 41 by press-fitting as in the present embodiment, the cam clutch unit can be used as a cam clutch unit that does not have a cage ring, and in this case, a housing (not shown) for holding said cam clutch unit itself comes into contact with the pin portion 42 protruding outwardly from the roller portion 41. Accordingly, even if such a structure is constructed, the pin portion 42 protruding outwardly from the roller portion 41 comes into contact with the housing, so that the contact area can be reduced, and frictional sliding between the roller 40 and the housing can be reduced.

### Modifications

The present invention is not limited to the embodiments described above. For example, in any of the embodiments, the materials constituting the pin portions 22, 32, and 42 are not limited to steel materials, but may be made of resin or non-ferrous metal. In the embodiments described above, although both the two roller portions 21, 31, 41 are configured to be separate from the pin portions 22, 32, 42, the present invention is not limited thereto, and one of the two roller portions 21, 31, 41 is configured to be integrated with the pin portions 22, 32, 42, and only the other roller portions 21, 31, 41 may be provided separately. Even if one of the roller portions 21, 31, 41 and the pin portions 22, 32, 42 are integrally formed of the same member, the diameters of the pin portions 22, 32, 42 can be set arbitrarily due to the absence of the other roller portion 21, 31, 41.

What is claimed is:

1. A roller for use in a cam clutch unit including at least a plurality of cams arranged between an inner ring and an outer ring provided coaxially and relatively rotatably, and an annular spring for biasing the cams,
the roller being arranged between the inner ring and the outer ring with the cam, and
the roller comprising a pair of roller portions and a pin portion provided between the roller portions, wherein at least one of the roller portions and the pin portion are separate entities.

2. The roller according to claim 1, wherein the roller portion separate from the pin portion is provided with a through hole penetrating an end surface thereof, and the pin portion is inserted into the through hole.

3. The roller according to claim 1, wherein a recess portion is formed on one end surface of the roller portion separate from the pin portion, and the pin portion is inserted into the recess portion.

4. The roller according to claim 2, wherein the pin portion penetrates the through hole so as to protrude outwardly from the end surface on the outside of the roller portion.

5. The roller according to claim 1, wherein the pin portion is provided by being clearance-fit with respect to the roller portion.

6. The roller according to claim 1, wherein the roller portions and the pin portion are separate from each other.

7. A cam clutch unit, comprising, at least:
a plurality of cams arranged between an inner ring and an outer ring that are provided coaxially and relatively rotatably;
the roller according to claim 1; and
an annular spring for biasing the cams.
